(19) United States
(12) Patent Application Publication
(10) Pub. No.: US 2024/0284565 A1
(43) Pub. Date: Aug. 22, 2024

(54) COOKING HOB WITH HOUSING

(71) Applicant: ELECTROLUX APPLIANCES AKTIEBOLAG, Stockholm (SE)

(72) Inventors: Holger WUNDLING, Rothenberg ob der Tauber (DE); Lukasz WASINKIEWICZ, Rothenberg ob der Tauber (DE); Claudio PAOLINI, Forli (IT); Emanuel URGESE, Forli (IT); Massimo ZANGOLI, Forli (IT); Massimo NOSTRO, Forli (IT); Alex VIROLI, Forli (IT); Adriano SCOTTO D'APOLLONIA, Forli (IT); Björn LEYH, Rothenburg ob der Tauber (DE)

(21) Appl. No.: 18/570,702

(22) PCT Filed: May 23, 2022
(86) PCT No.: PCT/EP2022/063873

§ 371 Date: Dec. 15, 2023

(30) Foreign Application Priority Data
Jun. 15, 2021 (EP) 21179405.2

(51) Int. Cl. H05B 6/12; H05B 1/02

(52) U.S. Cl. CPC H05B 6/1209; H05B 1/0266

(57) ABSTRACT

Cooking hob, in particular induction cooking hob, including a housing (10) having a housing bottom wall (12) and housing sidewalls (14a-d, 34) connected with a cooking hob plate of the cooking hob, wherein the housing (10) forms at least one interior space (16) in which electric and/or electronic components of the cooking hob are arrangeable or arranged, wherein the housing (10) comprises at least one electric terminal (28) being formed integrally to the housing (10) and/or wherein at least one section of one of the housing side walls (14a-d, 34) is a double-walled section (46) having an inner wall (48) and an outer wall (54), wherein the outer wall (54) comprises at least one opening (62).

The present invention relates to a cooking hob, in particular an induction cooking hob.

DE 20 2004 008 514 U1 discloses an induction cooking hob having a housing made of plastic material and having one or more coil carriers for carrying one or more induction coils formed integral with the housing. Further, the housing may have integrally formed air inlets for connection with a fan and a fan housing and guiding elements for guiding cooling air.

It is an object of the present invention to provide an electrically safe cooking hob with a housing that can be manufactured in a simple and cost efficient way.

The object of the present invention is achieved by a cooking hob, in particular induction cooking hob, including a housing having a housing bottom wall and housing side walls connected with a cooking hob plate of the cooking hob, wherein the housing forms at least one interior space in which electric and/or electronic components of the cooking hob are arrangeable or arranged, wherein the housing comprises at least one electric terminal being formed integrally to the housing and/or wherein at least one section of one of the housing side walls is a double-walled section formed integrally to the housing and having an inner wall and an outer wall, wherein the outer wall comprises at least one opening.

The core of the invention is to provide integrally formed structures to a housing of a cooking hob, wherein those structures ensure a safe functionality of the cooking hob with respect to elements that have to be connected with the housing from outside, such as a mains supply cable or fastening elements, both of which being identified as inhering potential electrical hazards. A mains supply cable can be assembled to the housing of the cooking hob in a simple way, wherein the number of parts to be assembled is reduced. Further, the overall thickness of the electric terminal can be reduced compared to a separate electric terminal attached to a conventional housing. The provision of a section of one of the housing side walls as a double-walled section enables to electrically isolate a fastening element intended to fix a cooking hob plate to the housing by engagement of a snap element into the opening from electrically life parts that may be present inside the housing. In general, the invention improves the electrical safety of a cooking hob housing and is particularly advantageous when used with a housing of a cooking hob that is fully made from plastic material.

According to an advantageous embodiment of the invention, the electric terminal is formed, in particular integrally, to a first bottom wall of the housing bottom wall and/or to a second bottom wall of the housing bottom wall. Additionally, the second bottom wall may be arranged in a plane vertically above a plane in which the first bottom wall is arranged. Additionally or alternatively, the electric terminal may be, optionally integrally, formed to at least one of the housing side walls and/or to at least one interior side wall. Additionally or alternatively, the electric terminal may form a connecting passage for the electrical main supply from the outside of the cooking hob into the interior space.

Thus, the electric terminal can be positioned on the housing in a region, where access for the electric mains cable from outside of the housing can be advantageously provided and where the interior electric connections require a specific position of the electric terminal.

In a further advantageous embodiment, the electric terminal is configured to provide, in particular mechanical and/or fixing, connection for an electrical main supply to the cooking hob. The fixing connection may provide a rigid connection or a flexible connection. Additionally or alternatively, the electrical terminal is connectable or connected to at least one or more electric cables or at least one or more electric contact elements provided outside of the cooking hob and is connectable or connected to at least one or more electric cables or at least one or more electric contact elements provided inside of the cooking hob, in particular provided in the interior space of the housing.

Thus, a simple and efficient assembly of the electric cables or electric contact elements within the housing is enabled.

A further advantageous embodiment of the invention includes that the housing bottom wall comprises at least one first bottom wall and at least one second bottom wall, wherein the first and the second bottom wall extend, in particular horizontally, in different, in particular horizontal, planes. At least one interior side wall extends, in particular vertically, from the first bottom wall to the second bottom wall. The electric terminal may be formed, in particular integrally, to the interior side wall and/or to the first and/or second bottom wall.

Thus, the electric terminal would be positioned at a distance from the outermost circumference of the housing. Consequently, the electrical mains cable to be connected with the electric terminal would be protected on at least two sides by housing walls, i.e. the interior side wall and a bottom wall, which increases the safety against mechanical damage for the cable.

It is also advantageous that the housing comprises at least one interior side wall different from the housing side walls, wherein the interior side wall is arranged angled, in particular substantially perpendicular, relative to the housing bottom wall, in particular relative to the first and/or second bottom wall, and wherein the electric terminal is formed, in particular integrally, to the interior side wall and/or to the first and/or second bottom wall.

Also this embodiment provides a safe guidance for the electrical mains cable towards the electrical terminal, wherein the housing is still simple to manufacture.

A further advantageous embodiment of the invention comprises that the electric terminal is configured to receive at least one, in particular a plurality of, electrical contact elements, in particular substantially rigid electrical contact tabs. The cooking hob may further comprise at least one printed circuit board, that is arrangeable in the interior space of the housing. Additionally, the electrical contact elements may be arranged on the printed circuit board and may be inserted into the electric terminal while the printed circuit board can be positioned angularly or slanted relative to the first and/or second bottom wall in a mounting position and wherein the printed circuit board can be moved pivotally into a fixation position parallel to the first and/or second bottom wall, in which the printed circuit board is fixable or fixed to the housing and wherein the electrical contact elements are in a fixed mounted position within the electric terminal, when the printed circuit board is in the fixation position.

This configuration of the electric terminal allows a simple assembly process for the printed circuit board arranged within the housing. Additionally, wiring that requires connection within the housing in the assembly process can be avoided, since the electrical contact elements, in particular when provided as rigid electrical contact tabs, can easily be connected with the electric terminal by means of the pivotal movement for fixedly mounting of the printed circuit board.

Furthermore, it is advantageous that the electric terminal comprises a side that faces the outside of the cooking hob and wherein at least one or more thread holes are integrally formed to the electric terminal on this side, wherein clamping screws cooperate with the threads of the thread holes by clamping wires of the electrical mains supply to the electric terminal and/or wherein the electric terminal comprises at least one cable clamping screw for clamping at least one cable of the electrical mains supply to the electric terminal by cooperating with at least one of the threads of the thread holes.

Thus, the manufacturing process can be simplified by further reducing the necessary parts to be assembled. Additionally, the connection process for connecting the electrical mains cable to the electric terminal is simplified.

Further advantageous is a cooking hob that comprises a cooking hob plate that is fixable or fixed to the housing by at least one, in particular at least partially electrically conducting, fastening element being fixedly attached to, in particular a lower side of, the cooking hob plate, wherein the at least one fastening element, in particular comprises at least one snap element that, is fixingly engageable or fixingly engaged with the opening.

A snap element that may engage with the opening may be get in contact to electrically life parts inside the housing. The provision of a double-walled section prevents the snap element from becoming electrically live. In this way, it becomes possible to avoid grounding of electronic parts inside the housing, leading to a reduction of parts and assembling steps. Further, a grounding wire for the electrical mains supply cable and/or the electric terminal can be avoided.

According to a further advantageous embodiment, the at least one double-walled section comprises at least a part of a housing side wall and/or one or two or more lateral walls and/or an inner wall, in particular wherein the housing side wall is the outer wall comprising the at least one opening and/or wherein the double-walled section is formed integrally to the housing.

Thus, the opening in the outer wall is protected from the interior space. Forming all walls integrally to the housing is specifically advantageous if the housing is made of plastic material.

Furthermore, it is advantageous that the inner wall is configured to be in direct contact to the cooking hob plate when the cooking hob plate is fixed to the housing, wherein the outer wall is configured to be not in direct contact to the cooking hob plate when the cooking hob plate is fixed to the housing.

In such a configuration, a part of the fastening element such as an attachment element for attaching the fastening element to the cooking hob may be arranged in a gap between the cooking hob plate and the outer wall, wherein the inner wall electrically seals off the attachment element from the electrically life parts inside the housing.

According to another aspect, the object of the invention is solved alternatively or in combination with any of the foregoing aspects, by a cooking hob, in particular induction cooking hob, including a housing having a housing bottom wall and housing side walls connected with a cooking hob plate of the cooking hob, wherein the housing forms at least one interior space in which electric and/or electronic components of the cooking hob are arrangeable or arranged, wherein the electric and/or electronic components comprise at least one user interface unit and wherein the housing comprises a seat structure providing a seat for the user interface unit below the cooking hob plate.

Thus, a support for a user interface is provided in a simple and efficient way on the cooking hob housing.

According to an advantageous embodiment, the seat structure comprises at least parts of at least one or two or more housing side walls. Additionally or alternatively, at least one or two or three or four or more support structures, in particular support walls, being different from the housing side walls are provided which form the seat structure at least partially, in particular as a whole, in particular wherein an upper edge of the seat structure is arranged lower than an upper edge of the housing side walls which is in contact with the cooking hob plate. Additionally or alternatively, the seat structure may be formed integrally to the housing.

Thus, a seat structure is provided that allows support for the user interface within the housing, wherein the housing side walls and the cooking hob plate fully enclose the user interface.

Advantageously, the user interface unit is arranged in the seat. Thus, a cooking hob is provided having a user interface securely supported within the housing.

According to a further advantageous embodiment of the invention, the user interface unit is in contact with the lower side of the cooking hob plate or wherein the user interface unit is pressed against the lower side of the cooking hob plate.

Specifically touch sensitive user interfaces are pressed against the lower side of the cooking hob plate. Thus, the user interface is fixed safely in its operation position.

According to another advantageous embodiment, the seat structure forms an enclosed space arranged within the interior space of the housing, in particular wherein the enclosed space comprises at least four support walls and a part of the housing bottom wall, preferably wherein the at least four support walls and the part of the housing bottom wall form a substantially quadrilateral box.

Thus, the lower side of the user interface is separated from other electrical and electronical elements disposed within the housing. Such a separation may be desireable e.g. during the assembly process.

Additionally advantageously, the enclosed space forms an at least partially enclosed partition of the interior space of the housing into which the user interface unit at least partially projects and/or wherein the enclosed space forms an at least partially enclosed partition of the interior space of the housing that is separated from the outside of the cooking hob and/or from the remaining interior space of the housing.

Thus, a space is created within the housing, in which e.g. connecting means of the user interface may protrude. Cables, e.g. from the printed circuit board or from a control board may connect with the connecting means of the user interface. The connection means are thus at least partially shielded from heat being generated within the interior space of the housing.

Further advantageously, the seat structure forms or comprises at least one, in particular circumferential, recess or groove or rebate, in particular arranged in or on or at an upper edge of the support walls and/or the housing side walls, wherein the user interface unit comprises at least one plate-like structure, in particular a printed circuit board, being arranged within the recess or groove or rebate.

Thus, the user interface can be positioned in a very easy and precise way in the seat structure.

According to a further advantageous embodiment of the invention, the support walls comprise at least one opening forming a passage to the remaining interior space of the housing, in particular wherein cables connecting the user interface unit with a second printed circuit board being arranged within the interior space of the housing pass through the opening.

Thus, a very simple electrical and/or data connection between the circuit board and the user interface can be established.

Novel and inventive features of the present invention are set forth in the appended claims.

The present invention will be described in further detail with reference to the drawings, in which

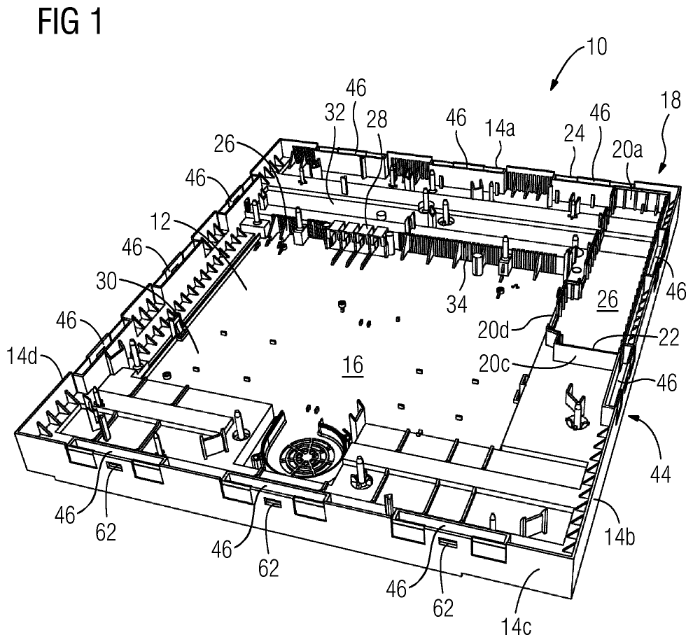

FIG. 1 is a perspective view of an empty housing without any non integral components according to an exemplary embodiment of the invention;

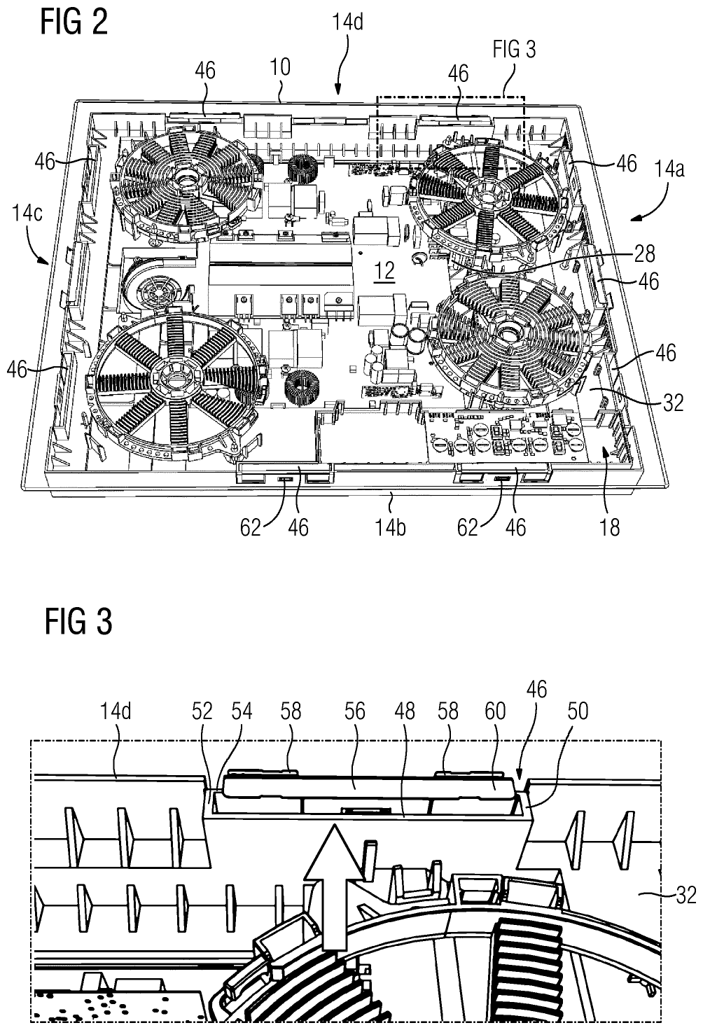

FIG. 2 is a perspective view of the housing according to FIG. 1 having electrical and electronical components arranged therein;

FIG. 3 is an enlarged view of the section as indicated in FIG. 2;

FIG. 1 illustrates a housing 10 having a housing bottom wall 12 and four housing side walls 14a-14d. The housing bottom wall 12 may comprise at least first and second housing bottom walls 30, 32 and also any number of housing bottom walls that may be appropriate. The housing bottom wall 12 and the housing side walls 14a-14d define an interior space 16 which is fully enclosed by the housing 10 when being attached to a not illustrated cooking hob plate of the cooking hob. The housing 10 has a front side 44 for being arranged on that side of the cooking hob intended to be arranged in front of the user's position when operating the cooking hob.

The first and second housing bottom walls 30, 32 are oriented substantially horizontal, but may have at least sections, in which they are oriented non-horizontally. A first housing bottom wall 30 may be a center housing bottom wall, wherein a second housing bottom wall 32 and further housing bottom walls may be peripheral housing bottom walls that may be arranged adjoining to the housing side walls 14a-14d. The housing side walls 14a14d shall be understood as the circumferentially outermost housing side walls.

The housing side walls 14a-14d extend substantially vertically and upwards from the adjoining housing bottom walls 30, 32 towards the cooking hob plate. Additionally, the housing 10 comprises one or more interior side walls 34 which are distanced from the outermost side walls 14a-14d. The interior side wall 34 extends substantially vertically from the first bottom wall 30 to the second bottom wall 32. Further interior side walls may extend from the first bottom wall 30 towards further bottom walls. Thus, separate mounting planes are created within the housing 10, wherein the first bottom wall 30 defines a first mounting plane and the second bottom wall 32 and any further bottom wall define a second mounting plane. It shall be acknowledged that one or more or all of a plurality of bottom walls may be arranged at a different height level, i.e. one vertically above another, resulting in different mounting planes, each one defined by a respective bottom wall.

In the illustrated embodiment, the housing side wall 14a which is the right hand housing side wall as seen from a user's perspective standing in front of the cooking hob comprises a plurality of air outlets for allowing a cooling air flow to leave the interior space 16 towards the exterior side of the housing 10.

Additionally, the interior side wall 34 comprises a plurality of similar air outlets. Also the interior side wall 34 is a right hand side wall as seen from a user's perspective. Different to the air outlets of the housing side wall 14a, the air outlets of the interior side wall 34 are provided substantially over the full length of the interior side wall 34.

An electric terminal 28 for contacting electrical mains to the housing is formed integrally to the housing 10. In the illustrated embodiment, the electrical terminal 28 is integrally formed to the interior side wall 34. Optionally, the electrical terminal 28 may separate the air outlets provided in the interior side wall 34. Also optionally, the electrical terminal 28 may be accessible for electrical contact elements, in particular substantially rigid flat electrical contact tab elements, in that side of the electrical terminal 28 that faces the interior space 16, wherein the electrical terminal 28 may be accessible for one or more cables of an electrical mains supply from that side facing the outside of the housing 10.

Furthermore, the electrical terminal 28 extends from the first bottom wall 30 to the second bottom wall 32. Thus, the electrical terminal forms a passage for the electrical mains supply. One or more cables which represent the electrical mains supply, may be attached to the housing 10 from the exterior side at the electrical terminal 28. Further, these cables can be mechanically fixed to the electrical terminal 28, e.g. by screws that can be screwed from the outside of the housing 10. Alternatively, it is possible to make the screws accessible for a tool from the inside.

The electrical terminal 28 has openings directed towards the interior space 16 which allow insertion of electrical contact elements, e.g. substantially rigid flat electrical contact tab elements, that may be attached, e.g. soldered, to a printed circuit board.

The printed circuit board may be configured with the electrical contact elements such that the electrical contact elements can be inserted into the openings of electric terminal 28, while the printed circuit board is positioned angularly or slanted relative to the first and/or second bottom wall 30, 32 in a mounting position. Subsequently, the printed circuit board can be moved pivotally into a fixation position parallel to the first and/or second bottom wall 30, 32, in which the printed circuit board is fixable or fixed to the housing 10. In the fixation position, the electrical contact elements are in a fixed mounted position within the electric terminal 28.

The fixed mounted position of the electrical contact elements within the electric terminal 28 enables to connect the electrical contact elements in a simple way by mechanical contact and screw fixation within the electrical terminal 28.

The electric terminal 28 further may comprise a side that faces the outside of the cooking hob. At least one or more thread holes are integrally formed to the electric terminal 28 on this side. Clamping screws or any other appropriate contact fixation means cooperate with the threads of the thread holes by clamping the wires of the electrical mains supply to the electric terminal 28. the electric terminal 28 comprises at least one cable clamping screw for clamping at least one cable of the electrical mains supply to the electric terminal 28 by cooperating with at least one of the threads of the thread holes.

Furthermore, it is possible that the housing 10 forms a seat structure 18 for providing a seat for a user interface unit to be arranged below the cooking hob plate. The seat structure 18 may be formed by the housing side walls 14a-d and/or by additional support walls 20a-d being different from the housing side walls 14a-d.

An upper edge 22 of the seat structure is arranged lower than an upper edge 24 of the housing side walls 14a-d which is in contact with the cooking hob plate. Additionally or alternatively, the seat structure 18 may be formed integrally to the housing 10.

A user interface unit can be seated in the seat formed by the seat structure 18 and may be in contact with the lower side of the cooking hob plate for forming, e.g. a touch sensitive control surface. For this purpose, the user interface unit may be pressed against the lower side of the cooking hob plate.

Furthermore, the seat structure 18 forms an enclosed space arranged within the interior space 16 of the housing 10. Optionally, the enclosed space may comprise at least four support walls 20a-d and a part of the housing bottom wall 12. Preferably, the at least four support walls 20a-d and the part of the housing bottom wall 12 may form a substantially quadrilateral box, wherein further electric or electronic components may be arranged.

The enclosed space may form an at least partially enclosed partition 26 of the interior space 16 of the housing 10 into which the user interface unit at least partially projects. The enclosed space may form an at least partially enclosed partition 26 of the interior space 16 of the housing 10 that is separated from the outside of the cooking hob and/or from the remaining interior space 16 of the housing 10. Thus, the electric and/or electronic elements arranged within the partition 26 are well protected.

The seat structure 18 may form or comprise at least one circumferential recess or groove or rebate that may be arranged in or on or at an upper edge of the support walls 20a-d and/or the housing side walls 14a-d. The user interface unit may comprise at least one plate-like structure, in particular a printed circuit board, being arranged within the recess or groove or rebate.

Further, the support walls 20a-d may comprise at least one opening forming a passage to the remaining interior space of the housing 10. Cables passing through the opening may connect the user interface unit with a second printed circuit board being arranged within the interior space 16 of the housing 10.

FIG. 1 and FIG. 2 show a plurality of double-walled sections 46 provided on each of the housing side walls 14a-14d. FIG. 3 shows and enlarged view of such a double-walled section 46.

The double-walled section 46 comprises an inner wall 48, an outer wall 54 and lateral walls 50, 52. The outer wall 54 forms part of the housing side wall 14d. The walls 48, 54, 50, 52 form an enclosure or a box. Further, the outer wall 54 comprises an opening 62 which is adapted to be engaged by a snap element of a fastening element 56.

The fastening element 56 is made of metal and comprises the snap element for engaging the opening 62, an attachment element 60 for being attached to the lower side of a cooking hob plate, e.g. by gluing the attachment element 60 to the cooking hob plate, and contact tongues 58 for contacting a worktop in which the cooking hob is insertable. If fastening elements 56 are distributed on all sides of the cooking hob, the contact tongues are able to resiliently center the cooking hob within a cutout the worktop.

For the purpose of assembling the housing 10 with the cooking hob plate, the fastening elements 56 are fixed to the lower side of the cooking hob plate in positions which allow to move the housing 10 towards the cooking hob plate such that the snap elements of the fastening elements 56 are enabled to engage into the openings 62 and, thus, firmly, but releasably attach the cooking hob plate to the housing. At the same time, the contact tongues 58 extend away from the housing 10 in such way that, when the cooking hob is inserted into the worktop cutout, the contact tongues 58 center and secure the cooking hob within the cutout.

The double-walled section 46 prevents the snap element of the fastening element 56 from getting into electrical contact with electrically live parts inside the housing 10. Thus, it is possible to avoid the requirement of providing a grounding for components insider the housing 10, specifically, when the housing is made of plastic material.

List of reference numerals

| | |
|---|---|
| 10 | housing |
| 12 | housing bottom wall |
| 14a-d | housing side walls |
| 16 | interior space |
| 18 | seat structure |
| 20a-d | support walls |
| 22 | upper edge of seat structure |
| 24 | upper edge of housing side walls |
| 26 | partition |
| 28 | electric terminal |
| 30 | first bottom wall |
| 32 | second bottom wall |
| 34 | interior side wall |
| 36 | third bottom wall |
| 44 | front side |
| 46 | double-walled section |
| 48 | inner wall |
| 50, 52 | lateral walls |
| 54 | outer wall |
| 56 | fastening element |
| 58 | contact tongues |
| 60 | attachment element |
| 62 | opening |

1. Cooking hob, including a housing having a housing bottom wall and housing side walls connected with a cooking hob plate of the cooking hob, wherein the housing forms an interior space in which electric and/or electronic components of the cooking hob are arrangeable or arranged, wherein the housing comprises an electric terminal formed integrally to the housing, and/or wherein a section of a said side wall is a double-walled section formed integrally to the housing and having an inner wall and an outer wall, wherein the outer wall comprises an opening.

2. Cooking hob according to claim 1, wherein the electric terminal is formed integrally to a first bottom wall of the housing bottom wall and/or to a second bottom wall of the housing bottom wall, wherein the second bottom wall is arranged in a plane vertically above a plane in which the first bottom wall is arranged, and/or to a said housing side walls and/or to an interior side wall,
and/or wherein the electric terminal forms a connecting passage for an electrical main supply from outside of the cooking hob into the interior space.

3. Cooking hob according to claim 1, wherein the electric terminal is configured to provide connection for an electrical main supply to the cooking hob,
and/or wherein the electrical terminal is connectable or connected to a cable or to an electric contact elements provided outside of the cooking hob, and is connectable or connected to an electric cable or to a contact elements provided inside the interior space of the housing.

4. Cooking hob according to claim 1, wherein the housing bottom wall comprises a first bottom wall and a second bottom wall, wherein the first and the second bottom walls extend horizontally in different horizontal, planes, and wherein an interior side wall extends vertically from the first bottom wall to the second bottom wall, wherein the electric terminal is formed integrally to the interior side wall and/or to the first and/or second bottom wall.

5. Cooking hob according to claim 1, wherein the housing comprises an interior side wall different from the housing side walls, wherein the interior side wall is arranged angled relative to a first and/or second bottom wall of the housing bottom wall, and wherein the electric terminal is formed integrally to the interior side wall and/or to the first and/or second bottom wall.

6. Cooking hob according to claim 1, wherein the electric terminal is configured to receive a plurality of substantially rigid electrical contact tabs, wherein the cooking hob further comprises a printed circuit board that is arrangeable in the interior space of the housing, wherein the electrical contact tabs are arranged on the printed circuit board and can be inserted into the electric terminal while the printed circuit board can be positioned angularly or slanted relative to first and/or second bottom walls of the housing bottom wall in a mounting position, and wherein the printed circuit board can be moved pivotally into a fixation position parallel to the first and/or second bottom wall, in which the printed circuit board is fixable or fixed to the housing, and wherein the electrical contact tabs are in a fixed mounted position within the electric terminal, when the printed circuit board is in the fixation position.

7. Cooking hob according to claim 1, wherein the electric terminal comprises a side that faces outside of the cooking hob and wherein a thread holes is integrally formed to the electric terminal on this side, wherein clamping screws cooperate with threads of the thread holes by clamping wires of an electrical mains supply to the electric terminal, and/or wherein the electric terminal comprises a cable clamping screw for clamping a cable of the electrical main supply to the electric terminal by cooperating with the threads of the thread hole.

8. Cooking hob according to claim 1, wherein the cooking hob plate is fixable or fixed to the housing by an at least partially electrically conducting fastening element being fixedly attached to the cooking hob plate, wherein the fastening element comprises a snap element that; is fixingly engageable or fixingly engaged with the opening.

9. Cooking hob according to claim 1, wherein the double-walled section comprises at least a part of a said housing side wall and/or one or two or more lateral walls and/or an inner wall, wherein the said housing side wall is the outer wall comprising the opening.

10. Cooking hob according to claim 9, wherein the inner wall is configured to be in direct contact to the cooking hob plate when the cooking hob plate is fixed to the housing, wherein the outer wall is configured to be not in direct contact to the cooking hob plate when the cooking hob plate is fixed to the housing.

11. Cooking hob, according to claim 1, wherein the electric and/or electronic components comprise a user interface unit and wherein the housing comprises a seat structure providing a seat for the user interface unit below the cooking hob plate.

12. Cooking hob according to claim 11, wherein: the seat structure comprises at least parts of a said housing side wall, and/or a further support wall, different from the housing side walls, is provided to at least partially form the seat structure, wherein an upper edge of the seat structure is arranged lower than an upper edge of the housing side walls which is in contact with the cooking hob plate, and/or the seat structure is formed integrally to the housing, and/or the user interface unit is arranged in the seat, and/or the user interface unit is in contact with a lower side of the cooking hob plate or wherein the user interface unit is pressed against the lower side of the cooking hob plate.

13. Cooking hob according to claim 11, wherein the seat structure forms an enclosed space arranged within the interior space of the housing, wherein the enclosed space comprises at least four further support walls and a part of the housing bottom wall, preferably the at least four further support walls and the part of the housing bottom wall form a substantially quadrilateral box, wherein the enclosed space forms an at least partially enclosed partition of the interior space of the housing into which the user interface unit at least partially projects, and/or wherein the enclosed space forms an at least partially enclosed partition of the interior space of the housing that is separated from outside of the cooking hob and/or from a remaining interior space of the housing.

14. Cooking hob according to claim 13, wherein the seat structure forms or comprises a circumferential recess or groove or rebate arranged in or on or at an upper edge of a further support walls and/or the housing side walls, wherein the user interface unit comprises a printed circuit board arranged within the recess or groove or rebate.

15. Cooking hob according to claim 12, wherein the further support wall comprises a further opening forming a passage to remaining interior space of the housing, wherein cables connecting the user interface unit with a second printed circuit board are arranged within the interior space of the housing pass through the further opening.

16. A cooking hob comprising:
a housing having a first, central bottom wall and a second, peripheral bottom wall, the first and second bottom walls both extending substantially horizontally and being disposed at different respective elevations, a housing side wall extending substantially vertically upward from the peripheral bottom wall, and an interior side wall extending substantially vertically between the first and second bottom walls, wherein the housing side wall and the first and second bottom walls together at least partially define an interior space of the housing;
a first air outlet disposed in and confined to a portion of the housing side wall, the first air outlet being configured to facilitate a passage of air from within the interior space, through the first air outlet in the housing side wall, to an exterior of the housing;
a plurality of second air outlets provided in, and distributed over a length of, the interior side wall; and
an electrical terminal integrally formed to the interior side wall, said electrical terminal comprising an electrical contact opening facing the interior space of the housing, and being further adapted to connect to a cable of a mains supply on a side of the electrical terminal facing away from the interior space;
wherein the electrical contact opening in said electrical terminal is adapted:
to receive an electrical contact tab, extending from an electric or electronic component to be installed within in the interior space, initially in a mounting position of said electric or electronic component,
and thereafter to accommodate moving of the electric or electronic component, and thereby of said electrical contact tab within the electrical contact opening, to a fixation position to complete installation of the electrical or electronic component within the interior space.

17. The cooking hob according to claim 16, further comprising a support wall integrally formed with said housing and at least partially defining a seat configured to accommodate a user interface unit therein; the support wall extending substantially vertically and having an upper edge that is recessed from an upper edge of the housing side wall; an enclosed space being at least partially defined, and separated from a remainder of the interior space within said housing, by the support wall; and an opening in said support wall configured to accommodate a cable extending therethrough.

18. The cooking hob according to claim 16, said housing side wall comprising a double-walled section having an inner wall and an outer wall at least partially defining a box, said box being adapted to accommodate a fastener of a cooking hob plate inserted therein from above in order to align and fasten the cooking hob plate to the housing.
